(19) United States
(12) Patent Application Publication
(10) Pub. No.: US 2026/0204003 A1
(43) Pub. Date: Jul. 16, 2026

(54) IMPOSTER IMAGES OF OBJECT GROUPS

(71) Applicant: thinAir Technologies, Inc., Covington, LA (US)

(72) Inventor: Jeremey Charbonnet, Covington, LA (US)

(21) Appl. No.: 19/444,845

(22) Filed: Jan. 9, 2026

Related U.S. Application Data
(60) Provisional application No. 63/745,717, filed on Jan. 15, 2025.

(51) Int. Cl. G06T 15/20; G06T 7/70; G06T 17/20

(52) U.S. Cl. CPC G06T 15/205; G06T 7/70; G06T 17/20; G06T 2200/04

(57) ABSTRACT

In one implementation, a method of rendering objects is performed by a device including a one or more processors and non-transitory memory. The method includes storing first object data for a first object including a location of the first object in an environment. The method includes storing second object data for a second object including a location of the second object in the environment. The method includes storing a set of imposter images of the first object and the second object. The method includes determining a location of a current perspective in the environment. The method includes determining a distance from the current perspective to the first object and the second object. The method includes, in accordance with a determination that the distance is below a threshold, rendering the first object and the second object from the current perspective. The method includes, in accordance with a determination that the distance is above the threshold, selecting one of the set of imposter images based on the location of the current perspective.

### CROSS-REFERENCES TO RELATED APPLICATIONS

This application claims priority to U.S. Provisional App. No. 63/745,717, filed on Jan. 15, 2025, which is hereby incorporated by reference in its entirety.

### TECHNICAL FIELD

The present disclosure generally relates to systems, methods, and devices of displaying a virtual environment.

### BACKGROUND

In various implementations, rendering a virtual environment for display includes rendering multiple objects at different depths.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1F illustrate a virtual environment during various time periods in accordance with some implementations.

FIG. 2 is a flowchart representation of a method of rendering objects in accordance with some implementations.

FIG. 3 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for rendering a virtual environment. In various implementations, the method is performed by a device having one or more processors and non-transitory memory. The method includes storing first object data for a first object including a location of the first object in an environment. The method includes storing second object data for a second object including a location of the second object in the environment. The method includes storing a set of imposter images of the first object and the second object. The method includes determining a location of a current perspective in the environment. The method includes determining a distance from the current perspective to the first object and the second object. The method includes, in accordance with a determination that the distance is below a threshold, rendering the first object and the second object from the current perspective. The method includes, in accordance with a determination that the distance is above the threshold, selecting one of the set of imposter images based on the location of the current perspective.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, rendering a virtual environment for display includes rendering multiple objects at different depths. Due to parallax, as the rendering perspective changes, the objects at different depths experience move on the display at different rates. In particular, in response to a change in the rendering perspective, objects that are closer to the rendering perspective move more than object that are farther from the rendering perspective.

However, rendering multiple objects can be computationally expensive. Accordingly, in various implementations, rather than rendering a three-dimensional mesh for each object, some objects are rendered as a two-dimensional imposter images at the location of the object. Thus, parallax between the front of the object and the back of object that would occur if the object were rendered is absent. However, at a large enough distance away from the rendering perspective, the difference in depth between the front of the object and the back of the object (and the resulting parallax) is minimal and can be ignored.

Similarly, when a group of objects are far from the rendering perspective, but are a similar distance away from the rendering perspective, the difference in depth between the closest object and the farthest object (and the resulting parallax) is also minimal. Accordingly, in various implementations, rendering of the group of objects is replaced with selection of an imposter image of the group of objects. In various implementations, the imposter image is selected from a set of pre-generated images which show the group of objects from various perspectives around the group of objects. In various implementations, one imposter image is generated in response to determining that an imposter image is to be used in rendering the virtual environment and the imposter image is selected from the set of one.

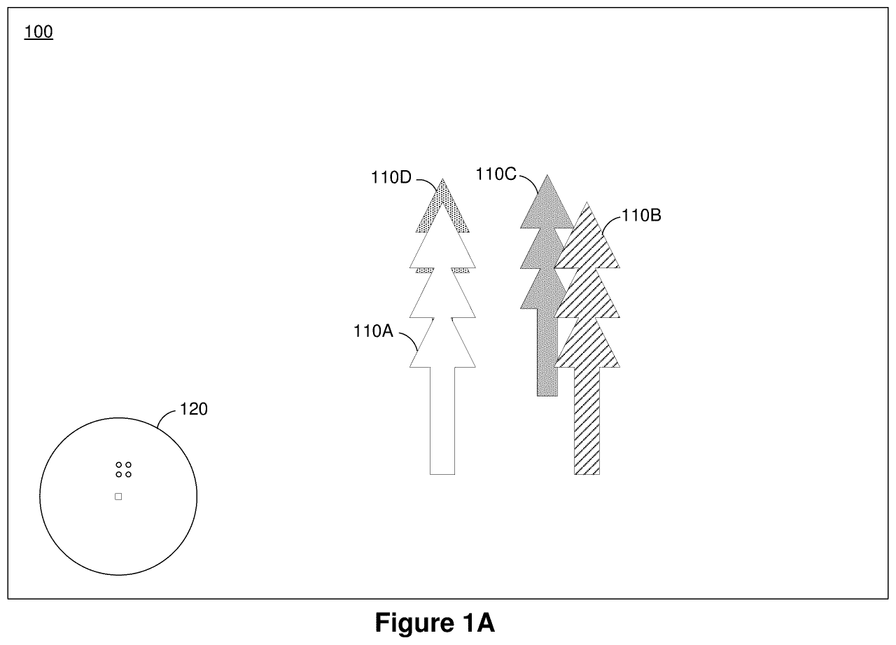

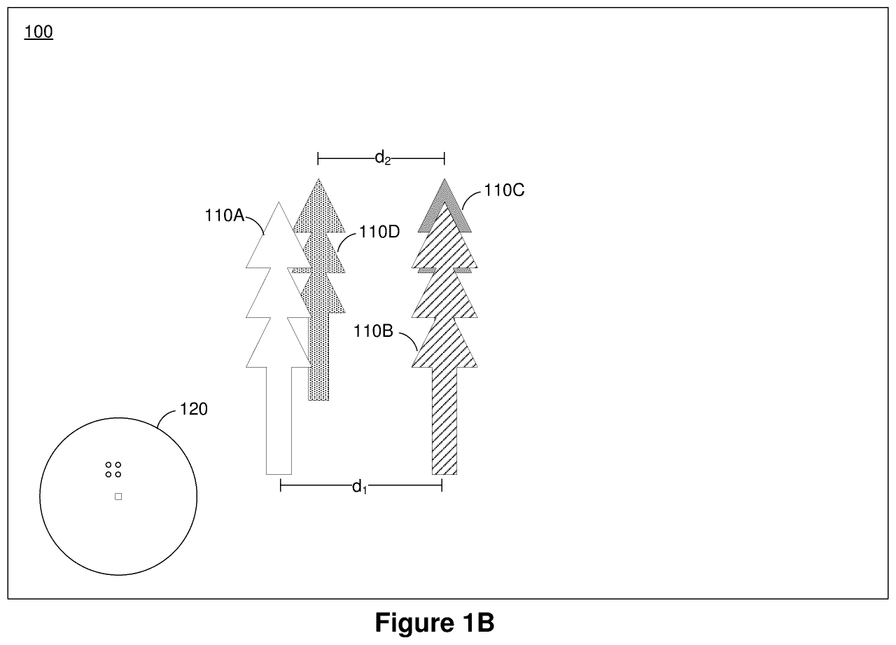

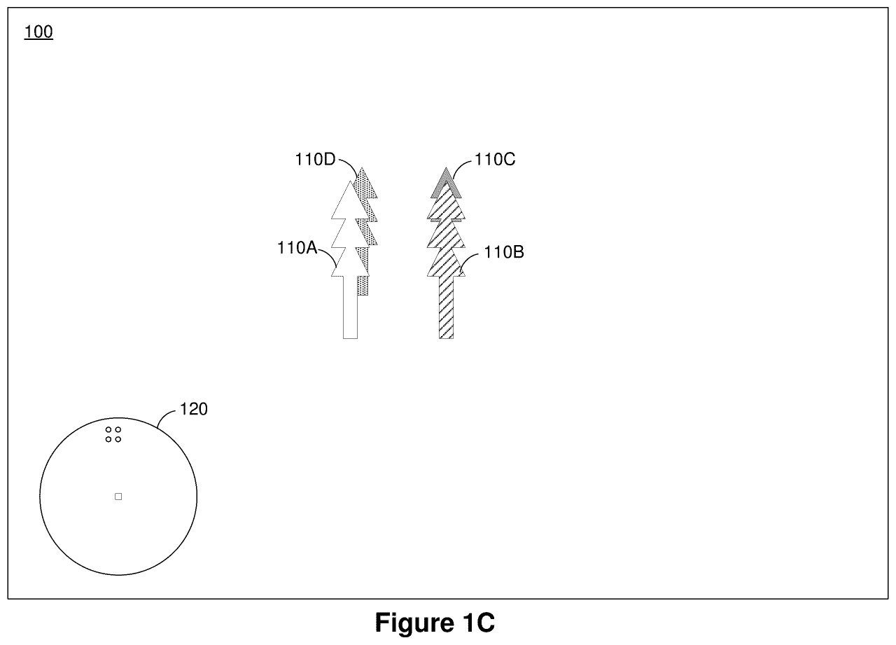

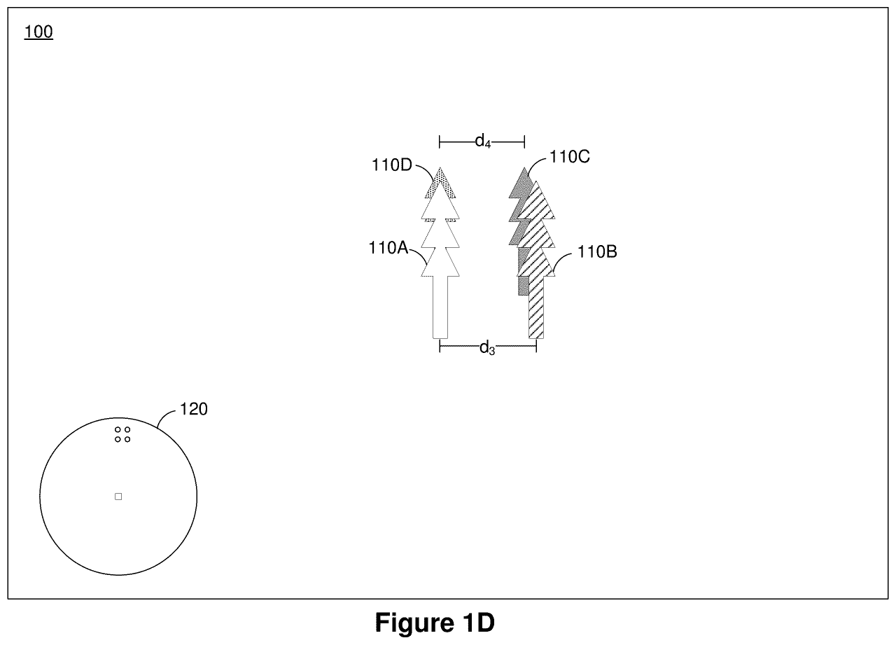

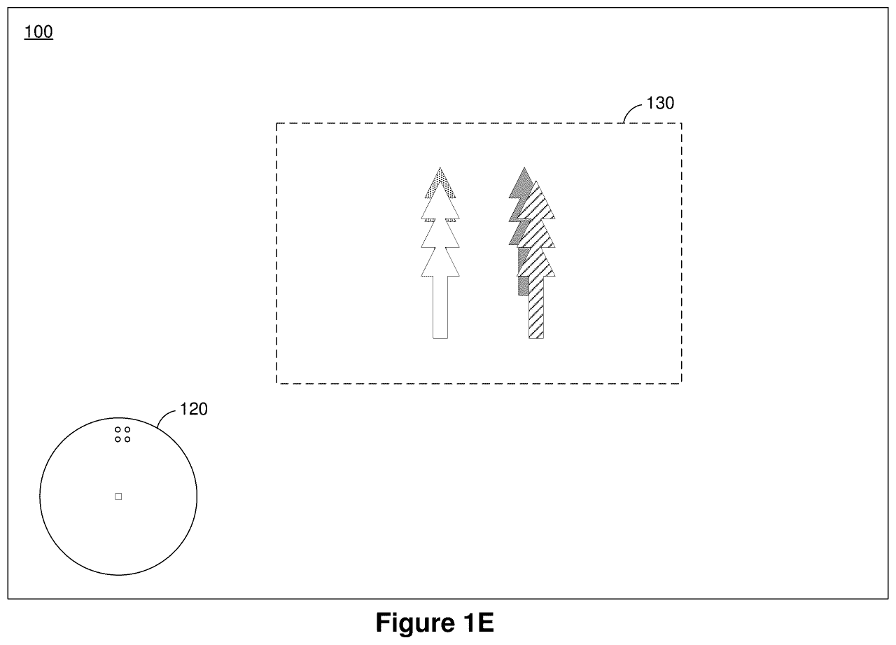

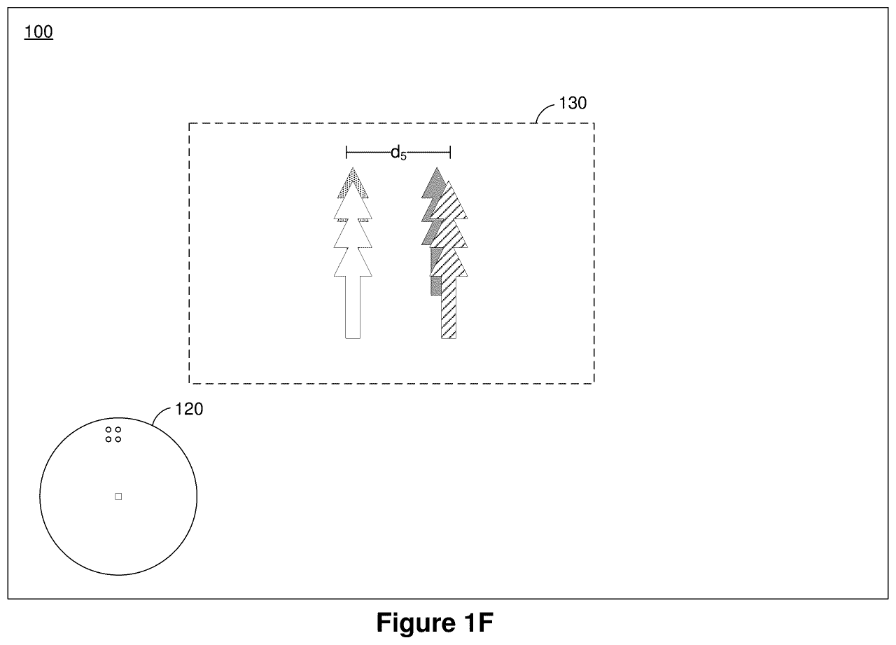

FIGS. 1A-1F illustrate a virtual environment 100 from a rendering perspective displayed, at least in part, by a display of an electronic device. In various implementations, the electronic device includes multiple displays (e.g., a left display positioned in front of a left eye of a user and a right display positioned in front of a right eye of the user) configured to provide a stereoscopic view of the virtual environment 100. For ease of illustration, FIGS. 1A-1F illustrate the virtual environment as presented on a single one of the multiple displays.

FIGS. 1A-1F illustrate the virtual environment 100 during a series of time periods. In various implementations, each time period is an instant, a fraction of a second, a few seconds, a few hours, a few days, or any length of time.

The virtual environment 100 includes a group of trees 110A-110D including a first tree 110A, a second tree 110B, a third tree 110C, and a fourth tree 110D. The virtual environment 100 further includes a minimap 120 illustrating the relative location of the rendering perspective to the group of trees 110A-110D.

In various implementations, the trees 110A-110D are presented at relative locations in the virtual environment 100, e.g., at a location defined by three coordinates in a three-dimensional (3D) coordinate system. Accordingly, when the rendering perspective moves in the virtual environment 100 (e.g., changes either position and/or orientation), the trees 110A-110D are moved on the display of the electronic device, but retain their location in the virtual environment 100. Such virtual objects that, in response to motion of the electronic device, move on the display, but retain their position in the virtual environment 100 are referred to as world-locked objects. In various implementations, minimap 120 is displayed at a location on the display such that when the rendering perspective moves in the virtual environment 100, the minimap 120 is stationary on the display. Such virtual objects that, in response to motion of the rendering perspective, retain their location on the display are referred to as display-locked objects.

FIG. 1A illustrates the virtual environment 100 during a first time period. During the first time period, in a virtual environment coordinate system, first tree 110A is two meters directly in front of the rendering perspective, the second tree 110B is one meter to the right of the first tree 110A, the third tree 110C is one meter behind the second tree 110B, and the fourth tree 110D is one meter to the left of the third tree 110C (and one meter behind the first tree 110A). During the first time period, the first tree 110A almost completely occludes the fourth tree 110D and the second tree 110B partially, but barely, occludes the third tree 110C.

FIG. 1B illustrates the virtual environment 100 during a second time period subsequent to the first time period. Between the first time period and the second time period, the rendering perspective has shifted one meter to the right in the virtual environment coordinate system. Accordingly, the location on the display in a display coordinate system of the first tree 110A and the second tree 110B have shifted to the left by a first distance d₁. Similarly, the location on the display in the display coordinate system of the third tree 110C and the fourth tree 110D have shifted to the left by a second distance d₂. Because the third tree 110C and the fourth tree 110D are farther away, the second distance d₂ is less than the first distance d₁. Having shifted, during the first time period, the first tree 110A only barely occludes the fourth tree 110D and the second tree 110B almost completely occludes the third tree 110C.

To determine the distance in the display coordinate system each tree has shifted, a camera projection matrix is used. For an object, the three-dimensional coordinates in the virtual environment coordinate system are transformed into a set of three-dimensional coordinates in a perspective coordinate system based on a position and orientation of the rendering perspective in the virtual environment coordinate system. The set of three-dimensional coordinates in the perspective coordinate system include a first coordinate that increases and decreases to the left and right of the optical axis, a second coordinate that increases and decreases above and below the optical axis, and a third coordinate that increases and decreases along the optical axis.

For a set of three-dimensional coordinates in a perspective coordinate system, (x₁, x₂, x₃), the set of two-dimensional coordinates in the display coordinate system, (y₁, y₂) are found using the following equation, where k is some constant and f is the focal length of the rendering:

$$[ \begin{matrix}{y}_{1} \\ {y}_{2} \\ 1\end{matrix} ] = k [ \begin{matrix}f & 0 & 0 & 0 \\ 0 & f & 0 & 0 \\ 0 & 0 & 1 & 0\end{matrix} ] [ \begin{matrix}{x}_{1} \\ {x}_{2} \\ {x}_{3} \\ 1\end{matrix} ] .$$

Thus, when the rendering perspective shifts to the left in the virtual world coordinate system, an object shifts to the right in the perspective coordinate system from a first location (x₁, x₂, x₃) to a second location (x₁+Δx, x₂, x₃). On the display, the object shifts from a first location (y₁, y₂) in the display coordinate system to a second location (y₁+fΔx/x₃, y₂)

$$[ \begin{matrix}{y}_{1} + \frac{f Δ x}{{x}_{3}} \\ {y}_{2} \\ 1\end{matrix} ] = k [ \begin{matrix}f & 0 & 0 & 0 \\ 0 & f & 0 & 0 \\ 0 & 0 & 1 & 0\end{matrix} ] [ \begin{matrix}{x}_{1} + Δ x \\ {x}_{2} \\ {x}_{3} \\ 1\end{matrix} ] .$$

Thus, the amount shifted in the display coordinate system is proportional to the shift in rendering perspective and inversely proportional to the depth along the optical axis of the rendering perspective. Thus, because the third tree 110C and the fourth tree 110D are at a depth of three meters and the first tree 110A and the second tree 110B are at a depth of two meters, the second distance d₂ is ⅔ the first distance d₁.

FIG. 1C illustrates the virtual environment 100 at a third time period subsequent to the second time period. Between the second time period and the second time period, the rendering perspective has shifted eight meters back in the virtual environment coordinate system. Accordingly, the group of trees 110A-110D is smaller in FIG. 1C than in FIG. 1B.

FIG. 1D illustrates the virtual environment 100 at a fourth time period subsequent the third time period. Between the third time period and the fourth time period, the rendering perspective has shifted one meter to the left in the virtual environment coordinate system. Accordingly, the location on the display in the display coordinate system of the first tree 110A and the second tree 110B have shifted to the right by a third distance d₃. Similarly, the location on the display in the display coordinate system of the third tree 110C and the fourth tree 110D have shifted to the right by a fourth distance d₄. Because the third tree 110C and the fourth tree 110D are farther away, the fourth distance d₄ is less than the third distance d₂. Because the third tree 110C and the fourth tree 110D are at a depth of ten meters and the first tree 110A and the second tree 110B are at a depth of nine meters, the fourth distance d₄ is 9/10 the third distance d₃.

In general, an object at a depth of n+Δn will shift n/(n+Δn) as much as an object at a depth of n. Thus, if two objects are at a similar depth, but n is large, the shifts can be approximated to be identical. Thus, in various implementations, in response to determining that the distance to a group of objects is above a threshold, rendering of the objects is replaced with selection of an imposter image of the group of objects.

FIG. 1E illustrates the virtual environment 100 at a fifth time period subsequent to the fourth time period. Between the fourth time period and the fifth time period, the group of trees 110A-110D has been replaced with an imposter image 130 of the tree. The dashed border of the imposter image 130 is shown in FIG. 1E for illustrative purposes only. During the fifth time period, the virtual environment 100 looks identical to the virtual environment during the fourth time period as shown in FIG. 1D.

In various implementations, in response to determining that the depth between the rendering perspective and the group of trees 110A-110D exceeds a threshold, the electronic device generates an imposter image of the group of trees 110A-110D from the rendering perspective. In various implementations, in response to determining that the depth between the rendering perspective and the group of trees 110A-110D exceeds a threshold, the electronic device selects the imposter image from a set of pre-generated images which show the group of trees 110A-110D from various perspectives around the group of objects.

FIG. 1F illustrates the virtual environment 100 at a sixth time period subsequent to the fifth time period. Between the fifth time period and the sixth time period, the rendering perspective has shifted one meter to the right in the virtual environment coordinate system. Accordingly, the location on the display in the display coordinate system of the imposter image 130 has shifted to the left by a fifth distance d₅. If the imposter image 130 is displayed at the depth of the first tree 110A and the second tree 110B, the fifth distance d₅ is equal to the third distance d₃. If the imposter image 130 is displayed at the depth of the third tree 110C and the fourth tree 110D, the fifth distance d₅ is equal to the fourth distance d₄. If the imposter image is displayed at depth between the depth of the first tree 110A and the fourth tree 110D, the fifth distance d₅ is between the third distance d₃ and the fourth distance d₄. Thus, each tree is shifted the same amount irrespective of depth.

Notably, the virtual environment 100 looks similar to, but not exactly like, the virtual environment 100 during the third time period illustrated in FIG. 1C. However, because each tree was shifted the same amount on the display, rather than a depth-dependent amount as is done when rendering each object, the location on the display of the trees is slightly different. At large distances, the difference may be negligible and/or unnoticeable and the computational savings in selecting an image over rendering multiple three-dimensional objects outweighs any noticeable difference.

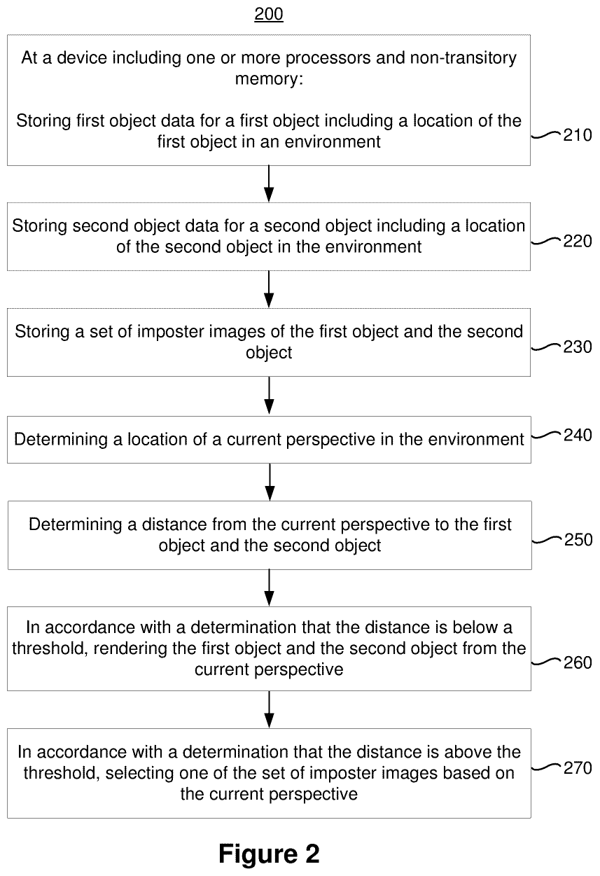

FIG. 2 is a flowchart representation of a method 200 of rendering objects in accordance with some implementations. In various implementations, the method 200 is performed by an electronic device. In various implementations, the method 200 is performed by a device one or more processors and non-transitory memory. In some implementations, the method 200 is performed by processing logic, including hardware, firmware, software, or a combination thereof. In some implementations, the method 200 is performed by a processor executing instructions (e.g., code) stored in a non-transitory computer-readable medium (e.g., a memory).

The method 200 begin, in block 210, with the electronic device storing first object data for a first object including a location of the first object in an environment. In various implementations, electronic device stores the location of the first object as a set of coordinates in a virtual environment coordinate system. In various implementations, the first object data further includes a mesh of the first object. In various implementations, the first object data includes multiple meshes of the first object with different numbers of polygons for rendering the first object at various levels of detail. In various implementations, the first object data includes a material of the first object that can be applied to a mesh. In various implementations, the first object data includes multiple materials of the first object with different resolutions for rendering the first object at various levels of detail. In various implementations, the first object data includes a first object-specific draw distance.

The method 200 continues, in block 220, with the electronic device storing second object data for a second object including a location of the second object in the environment. In various implementations, the electronic device stores the location of the second object as a set of coordinates in the virtual environment coordinate system. In various implementations, the electronic device stores the location of the second object as an offset from the location of the first object (e.g., a set of coordinates in a first object coordinate system). In various implementations, the second object data further includes a mesh of the second object. In various implementations, the second object data includes multiple meshes of the second object with different numbers of polygons for rendering the second object at various levels of detail. In various implementations, the second object data includes a material of the second object that can be applied to a mesh. In various implementations, the second object data includes multiple materials of the second object with different resolutions for rendering the second object at various levels of detail. In various implementations, the second object data includes a second object-specific draw distance.

In various implementations, the first object data and/or the second object data includes an association of the second object as a child object of the first object and/or an association of the first object as a parent object of the second object.

The method 200 continues, in block 230, with the electronic device storing a set of imposter images of the first object and the second object. In various implementations, the set of imposter images includes a single imposter image. In various implementations, the set of imposter images includes a plurality of imposter images. In various implementations, the imposter images include one or more imposter images of the first object and the second object from one or more perspectives. In various implementations, the set of imposter images includes imposter images of the first object and second object as rendered from a plurality of perspectives in a circle surrounding the first object and the second object. For example, in various implementations, the set of imposter images includes a set of eight imposter images rendered from perspectives at the midpoints of the sides of a regular octagon centered at and surrounding the first object and the second object. In various implementations, the set of imposter images includes imposter images from a plurality of perspectives at different distances. For example, in various implementations, the set of imposter images includes a first subset of imposter images rendered from a plurality of perspectives in a first circle having a first radius and surrounding the first object and the second object and a second subset of imposter images rendered from a plurality of perspectives in a second circle having a second radius different than the first radius and surrounding the first object and the second object.

In various implementations, the set of imposter images are pre-generated, e.g., before an instance of an environment including the first object and the second object is instantiated (and displayed). In various implementations, the set of imposter images are generate on-the-fly, e.g., while an instance of an environment including the first object and the second object is instantiated (and displayed).

The method 200 continues, in block 240, with the electronic device determining a location of a current perspective in the environment. In various implementations, a renderer renders an image including virtual objects from a certain perspective, which may include a position and orientation in the environment. The perspective may also be referred to as a “camera pose”. In various implementations, the current perspective is a perspective of an avatar of a user. In various implementations, a user can input commands to change the current perspective, e.g., by moving the avatar in the environment.

The method 200 continues, in block 250, with the electronic device determining a distance from the current perspective to the first object and the second object. In various implementations, determining the distance from the current perspective to the first object and the second object includes determining a minimum of a distance from the current perspective to the first object and a distance from the current perspective to the second object. In various implementations, determining the distance from the current perspective to the first object and the second object includes determining an average of a distance from the current perspective to the first object and a distance from the current perspective to the second object.

The method 200 continues, in block 260, with the electronic device, in accordance with a determination that the distance is below a threshold, rendering the first object and the second object from the perspective. For example, in FIG. 1B, the electronic device renders the group of trees 110A-110D in accordance with a determination that the distance to the group of trees 110A-110D is less than a threshold.

As noted above, in various implementations, the first object data includes a mesh of the first object. Thus, in various implementations, rendering the first object (in block 260) is based on the mesh. As also noted above, in various implementations, the first object data includes a material of the first object. Thus, in various implementations, rendering the first object (in block 260) is based on the material. In various implementations, rendering the first object and the second object is further based on lighting conditions in the environment and/or other object and/or environmental parameters.

The method 200 continues, in block 270, with the electronic device, in accordance with a determination that the distance is above the threshold, selecting one of the set of imposter images based on the current perspective. For example, in FIG. 1E, the electronic device displays the imposter image 130 in accordance with a determination that the distance to the group of trees 110A-110D is above the threshold.

In various implementations, the method 200 includes determining the threshold. In various implementations, the threshold is pre-determined for the first object and the second object. In various implementations, determining the threshold is based on a difference between a distance from the current perspective to the first object and a distance from the current perspective to the second object. Thus, when the first object and the second object are a similar distance from the current perspective, the threshold is smaller. Conversely, when the first object and the second object have very different distances from the current perspective, the threshold is larger.

In various implementations, determining the threshold is based on a distance from the current perspective to a prior perspective. For example, if an imposter image was displayed at the prior perspective and the distance between the current perspective and the prior perspective is small, the threshold can be large. However, if the current perspective is far from the prior perspective, the threshold can be smaller and the first object and second object are more likely to be rendered.

In various implementations, selecting the one of the set of imposter images based on the location of the current perspective is based on an angle from the current perspective to the first object and the second object. For example, in various implementations, each of the set of imposter images is associated with a perspective and an angle from the perspective to the first object and the second object. Thus, the electronic device selects the one of the set of imposter images having an angle that most closely matches the angle from the current perspective to the first object and the second object. In various implementations, each of the set of imposter images is also associated with a distance from the perspective to the first object and the second object. Thus, from among multiple imposter images with the same angle, the electronic device selects the one of the set of imposter images having a distance that most closely matches the distance from the current perspective to the first object and the second object.

As noted above, in various implementations, the set of imposter images are generated on-the-fly. Thus, in various implementations, the method 200 includes, in accordance with the determination that the distance is above the threshold, generating the set of imposter images. In various implementations, the electronic device generates a single imposter image and selects that imposter image.

In various implementations, the method 200 includes displaying a virtual environment including the rendering or the selected one of the imposter images. In various implementations, the selected one of the imposter images is displayed at the distance. For example, in various implementations, the selected one of the imposter images is displayed at the location of the first object, the location of the second object, or a location between the first object and the second object.

Although the method 200 has been described for a first object and a second object, it is to be appreciated that the method 200 can be applied to three objects, four objects, or any number of objects. For example, in FIG. 1F, the electronic device displays an imposter image 130 for a group of four objects, the group of trees 110A-110D.

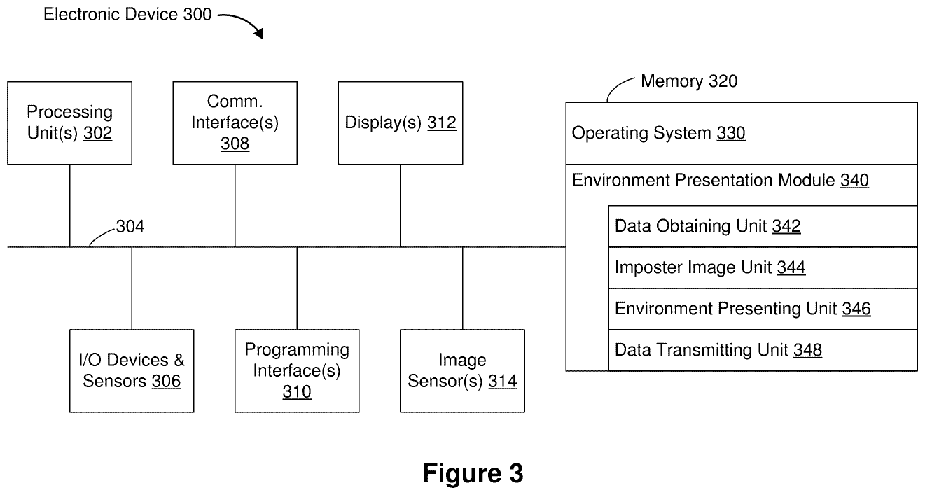

FIG. 3 is a block diagram of an example of an electronic device 300 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 300 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 312 are configured to display a virtual environment. In some implementations, the one or more displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 312 correspond to diffractive, reflective, polarized, holographic, etc. waveguide displays. In one example, the electronic device 300 includes a single display. In another example, the electronic device includes a display for each eye of the user. In some implementations, the one or more displays 312 are capable of presenting XR (extended reality) and VR (virtual reality) content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the physical environment as would be viewed by the user if the electronic device 300 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an environment presentation module 340.

The operating system 330 includes procedures for handling various basic system services and for performing hardware dependent tasks. In some implementations, the environment presentation module 340 is configured to present an environment to the user via the one or more displays 312. To that end, in various implementations, the environment presentation module 340 includes a data obtaining unit 342, an imposter image unit 344, an environment presenting unit 346, and a data transmitting unit 348.

In some implementations, the data obtaining unit 342 is configured to obtain data (e.g., presentation data, interaction data, sensor data, location data, etc.) from the other components of the electronic device 300 and/or a different electronic device. To that end, in various implementations, the data obtaining unit 342 includes instructions and/or logic therefor, and heuristics and metadata therefor.

In some implementations, the imposter image unit 344 is configured to generate one or more imposter images of two or more objects. To that end, in various implementations, the imposter image unit 344 includes instructions and/or logic therefor, and heuristics and metadata therefor.

In some implementations, the environment presenting unit 346 is configured to display, based on a distance to the two or more objects from a current perspective, either a rendering of the two or more objects or a selected imposter image of the two or more objects. To that end, in various implementations, the environment presenting unit 346 includes instructions and/or logic therefor, and heuristics and metadata therefor.

In some implementations, the data transmitting unit 348 is configured to transmit data (e.g., presentation data, location data, etc.) to other components of the electronic device 300 and/or a different electronic device. To that end, in various implementations, the data transmitting unit 348 includes instructions and/or logic therefor, and heuristics and metadata therefor.

Although the data obtaining unit 342, the imposter image unit 344, the environment presenting unit 346, and the data transmitting unit 348 are shown as residing on a single device (e.g., the electronic device 300), it should be understood that in other implementations, any combination of the data obtaining unit 342, the imposter image unit 344, the environment presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having one or more processors and non-transitory memory:
storing first object data for a first object including a location of the first object in an environment;
storing second object data for a second object including a location of the second object in the environment;
storing a set of imposter images of the first object and the second object;
determining a location of a current perspective in the environment;
determining a distance from the current perspective to the first object and the second object;
in accordance with a determination that the distance is below a threshold, rendering the first object and the second object from the current perspective; and
in accordance with a determination that the distance is above the threshold, selecting one of the set of imposter images based on the location of the current perspective.

2. The method of claim 1, wherein the first object data further includes a mesh of the first object and rendering the first object is based on the mesh.

3. The method of claim 1, wherein the first object data further includes a material of the first object and rendering the first object is based on the material.

4. The method of claim 1, wherein the set of imposter images includes one or more imposter images of the first object and the second object from one or more perspectives.

5. The method of claim 4, wherein the set of imposter images includes imposter images of the first object and the second object from a plurality of perspectives in a circle surrounding the first object and the second object.

6. The method of claim 4, wherein the set of imposter images includes imposter images of the first object and the second object from a plurality of perspectives at different distances.

7. The method of claim 1, wherein determining the distance from the current perspective to the first object and the second object includes determining a minimum of a distance from the current perspective to the first object and a distance from the current perspective to the second object.

8. The method of claim 1, wherein determining the distance from the current perspective to the first object and the second object includes determining an average of a distance from the current perspective to the first object and a distance from the current perspective to the second object.

9. The method of claim 1, further comprising determining the threshold, wherein determining the threshold is based on a difference between a distance from the current perspective to the first object and a distance from the current perspective to the second object.

10. The method of claim 1, further comprising determining the threshold, wherein determining the threshold is based on a distance from the current perspective to a prior perspective.

11. The method of claim 1, wherein selecting the one of the set of imposter images based on the location of the current perspective is based on an angle from the current perspective to the first object and the second object.

12. The method of claim 1, further comprising, in accordance with the determination that the distance is above the threshold, generating the set of imposter images.

13. The method of claim 1, further comprising displaying a virtual environment including the rendering of the selected one of the imposter images.

14. The method of claim 13, wherein the selected one of the imposter images is displayed at the distance.

15. A device comprising:
a non-transitory memory; and
one or more processors to:
store first object data for a first object including a location of the first object in an environment;
store second object data for a second object including a location of the second object in the environment;
store a set of imposter images of the first object and the second object;
determine a location of a current perspective in the environment;
determine a distance from the current perspective to the first object and the second object;
in accordance with a determination that the distance is below a threshold, render the first object and the second object from the current perspective; and
in accordance with a determination that the distance is above the threshold, select one of the set of imposter images based on the location of the current perspective.

16. The device of claim 15, wherein the set of imposter images includes one or more imposter images of the first object and the second object from one or more perspectives.

17. The device of claim 15, wherein the one or more processors are further to determine the threshold based on a difference between a distance from the current perspective to the first object and a distance from the current perspective to the second object.

18. The device of claim 15, wherein the one or more processors are to select the one of the set of imposter images based on an angle from the current perspective to the first object and the second object.

19. The device of claim 15, wherein the one or more processors are further to, in accordance with the determination that the distance is above the threshold, generate the set of imposter images.

20. A non-transitory memory storing one or more programs, which, when executed by one or more processors of a device, cause the device to:
store first object data for a first object including a location of the first object in an environment;
store second object data for a second object including a location of the second object in the environment;
store a set of imposter images of the first object and the second object;
determine a location of a current perspective in the environment;
determine a distance from the current perspective to the first object and the second object;
in accordance with a determination that the distance is below a threshold, render the first object and the second object from the current perspective; and
in accordance with a determination that the distance is above the threshold, select one of the set of imposter images based on the location of the current perspective.
